(19) United States
(12) Patent Application Publication
(10) Pub. No.: US 2016/0100015 A1
(43) Pub. Date: Apr. 7, 2016

(54) SYSTEMS AND METHODS FOR RESOLVING SERVICE INITIALIZATION LINKS IN VIRTUAL DESKTOP INFRASTRUCTURE ENVIRONMENTS

(71) Applicant: Vidyo, Inc., Hackensack, NJ (US)

(72) Inventors: Isaac Levy, New York, NY (US); Meir Sela, Cresskill, NJ (US)

(73) Assignee: Vidyo, Inc., Hackensack, NJ (US)

(21) Appl. No.: 14/507,543

(22) Filed: Oct. 6, 2014

(51) Int. Cl. H04L 29/08; H04L 29/06

(52) U.S. Cl. CPC H04L 67/141; H04L 67/42; H04L 67/10; H04L 67/28

(57) ABSTRACT

Systems and methods for resolving service initialization links in Virtual Desktop Infrastructure (VDI) environments are disclosed. Specifically, the links includes information that does not identify the originating user and are only associated with the offered service, whereas multiple users may be using the same service. The systems and methods involve a proxy component at the server as well as a plug-in at the client. The proxy is responsible for obtaining the service initialization information, identifying the correct session, and forwarding the service initialization information to the corresponding plug-in through the session. The plug-in, in turn, is responsible for forwarding the service initialization data back to the main application.

### FIELD

The disclosed subject matter relates to Virtual Desktop Infrastructure (VDI) environments.

### BACKGROUND

Desktop virtualization has emerged in enterprise computing as it separates the personal computer desktop environment that a user accesses during his/her work from the physical computer that this environment is running on. Desktop virtualization is an example of client-server computing—the client provides the front-end, and the actual “work” is performed at a server.

One example of a virtual desktop is the X Window System, which separated the display component (“Xserver”) from the client component (e.g., an “xterm”). The local machine, i.e., the machine that a user is currently using and which has the physical display, keyboard, and mouse, runs the “Xserver”. Programs that run on the local machine or remote machines can connect to the Xserver to perform display and obtain user input via the keyboard and mouse.

The Xlib protocol was used for communication between the client program (in this example xterm) and the X server. X Windows is more than a virtual desktop system, since it allowed an application to run on the local machine where the X server was running. That's because the local machine was typically a UNIX workstation. As such workstations became older, and slower than newer models, it became common in the early 1990's to build custom-made UNIX kernels that would just run an Xserver, thus transforming these older workstations to useful “X terminals”, i.e., standalone systems that would run an X server. Such systems are an early example of a virtual desktop.

The ad-hoc processes that were used with X Windows gave way to commercial products in what are now called “Virtual Desktop Infrastructure” or VDI environments. These are sophisticated enterprise systems that involve both hardware and software, and which are geared for deployment in companies with hundreds or thousands of desktops.

VDI environments can involve two components: a server component and a client component. The server component involves a server that can run multiple virtual machine (VM) instances. Each such VM runs an operating system of choice, together with any desired application software that is installed on it. The VM is the actual computer that the end users access. The client component of the VDI environment involves software that provides remote access to the remote VM running on the server. The client software is typically very small and efficient, and can run on simpler (and cheaper) hardware than the one running the VM. Some companies offering VDI solutions may bundle the client software together with hardware to run it. A commercially available example of a VDI system is VMware's View.

VDI systems allow the partitioning of computational capability so that the majority of the requirements falls on the server side rather than the client side. This is an advantage since the server component can be shared by many users and can be more easily managed. In addition, the client component can run on a wide array of different devices, including desktops, laptops, iPads, smartphones, etc., giving users s flexibility in terms of ways to access their data and applications.

FIG. 1 shows an example architecture of a VDI system 100. On the left side of the figure is a server system, which can include a VDI Server 154 which runs one or more instances of a Virtual Machine (VM) 155. On the right side of the figure is the VDI Client 156. Content display as well as user interaction (through a keyboard, mouse, microphone, etc.) can occur on the VDI Client 156. The VDI Server 154 and VDI Client 156 communicate through a Network Connection 160. The Network Connection 160 can be over the Internet, or any other suitable digital communication system.

One component of the architecture that can affect performance is the communication between the server and the client component. This is because the quality of the experience that the user enjoys can depend on the responsiveness of the system, as experienced on the client device. If, for example, it takes a considerable amount of time from the instance a user clicks a button until the button is shown to transition to its clicked state, it may be very frustrating. This transition depends on the amount of time it takes for the click event to be transmitted from the client to the server, the time it takes for the server to respond to the event, and for the screen update to propagate from the server to the client. This last component may be the one subject to the highest delay, since it can involve the transmission of non-trivial amounts of data from the server to the client. VDI environments can employ custom protocols to improve the communication of data from, at least, the server to the client and thus minimize both the bit rate needed as well as the delay.

As an example, the commercially available VMware View environment uses proprietary PCoIP protocol. Information on how PCoIP performs and how it may be optimized is available in the white paper “VMware View 5, Performance and Best Practices,” published by VMware and available on the web site http://www.vmware.com.

A very similar mechanism for implementing VDI systems is application virtualization. A commercially available example is Citrix XenApp. Application virtualization may not expose a VM 155 component, even if it used internally in its implementation, but for all practical purposes is a VDI environment for the purposes of the present disclosure. As an example, Citrix uses the HDX remote desktop protocol, which runs over TCP. VMware's PCoIP runs over UDP. Both, however, offer the same basic functionality. In the following we use the terms VDI, application virtualization, and Virtual Application Infrastructure (VAI) interchangeably, to refer to all such embodiments of client-server interactive computing environments.

Applications and services today are often accessed using Uniform Resource Locators, or URLs. URLs are defined in RFC 3986, “Uniform Resource Identifier (URI): Generic Syntax,” incorporated herein by reference in its entirety. The initial component of the URI is referred to as the ‘scheme’, and instructs the system where the URL is accessed now to locate the specific resource. For example, in the well-known ‘http’ scheme that is used in the Word Wide Web, the scheme component is followed by an IP address or domain name component. This instructs the system that wishes to access the resource to do the following: connect to the host identified by the IP address or domain name at its TCP port 80, and submit a “GET” request. The request is performed by sending the string “GET” followed by the identified source, as well as the protocol version (e.g., HTTP/1.1). For example, for the URL “http://www.example.com/index.html”, the GET request would involve transmitting the text:

GET /index.html HTTP/1.1
Host: www.example.com

over the TCP connection opened on port 80 with the host www.example.com. The HTTP server presumably running on the host www.example.com would then respond according the HTTP protocol. The HTTP protocol is defined in RFC 2616, “Hypertext Transfer Protocol—HTTP/1.1”, incorporated herein by reference in its entirety. The operation can be used to initiate actions on the server as well. The URL can be used to both select an appropriate action as well as pass application-specific parameters as needed.

When a URL is accessed in a device, the software that coordinates the operation of the device—typically its operating system—has ways to associate different URL “schemes” with programs that can service them. For example, when the “http” scheme is identified in a URL, the system will invoke a web browser. Personal computers may, in fact, feature multiple web browsers (e.g., Internet Explorer, Safari, Chrome, Mozilla). Their operating system, at the user's discretion, associates one of them as the default web browser so that when the user clicks on a URL the default web browser is invoked and provided with the clicked URL.

In the following we will refer for convenience to the software controlling the operation of a device as the operating system. In some embodiments of the disclosed subject matter the connected device may not have an operating system per se, and may be controlled by custom software that do not offer all the different types of services typically associated with a complete operating system.

The URL facility can be used to access resources using schemes different than “http”. In fact, any application may “register” its scheme with the operating system so that when a URL of the form “scheme::resource” is clicked—or, more generally, accessed—then the specific application is invoked to service the URL request. For example, a voice-over-IP application could register as a handler for the scheme “callto”, so that when a URL of the form “callto:+12125551212” is accessed, the application is invoked to make a call to the phone number “+12125551212”. RFC 2806, “URLs for Telephone Calls”, incorporated herein by reference in its entirety, is such an example set of schemes (“tel”, fax”, and “modem”), designed for accessing telephony services.

Applications are free to define their own schemes in the operating environment where they run. For example, one can initiate a call using Microsoft's Skype client using the following HTML code in a web page:

<a href=“skype:echo123?call”>Call the Skype Echo / Sound Test
Service</a>

This particular link will call Skype's Echo service. The mechanism through which this is performed, after the user selects (clicks) the particular URL, can be as follows:

(a) the system identifies the application responsible for handling the “skype” URL scheme, in this instance the Skype application installed on the local system;

(b) the Skype application will auto-login or prompt the user for their Skype name and password;

(c) the Skype application opens a confirmation dialog to authorize placing the call; and

(d) the Skype application places the call.

This mechanism allows users and systems to communicate URLs which, when accessed (clicked), initiate specific services for the users. Using the Skype example, one can send an email message to a colleague with a preformatted URL which, when clicked, will invoke Skype at the colleague's device and ask it to call the inviting user's phone number. The URL can be used to carry all necessary service initialization data.

Some applications may bypass the use of a separate URL scheme and rely on the standard HTTP scheme to access their services. This may be accomplished by a “helper” application which has to run on the device where the service is to be accessed, and which is capable of receiving HTTP requests. These requests do not have to be on the standard port 80, since the port number can be encoded in the URL itself. The helper application is always running and waits for connections. The URL (http-based) identifies the local host as the server (as “localhost”, or the default IPv4 address of 127.0.0.1, or ::1 for IPv6) so that the system connects to the helper application running on the system where the URL is accessed. The URL can then encode any other information that it wishes to pass to the helper application. In a communication application, it may be the phone number of the party to be called.

The helper application can be responsible for invoking the main application with the service initialization information provided. The helper application may be integrated with the main application. For example, it may be a separate thread that listens on a specified helper port.

Using a helper application can work on any operating environment, regardless if it supports protocol handlers for URL schemes or not. The only requirements are that the environment understands HTTP URLs and allows the running of HTTP servers.

The helper application acts as a “link proxy”: it allows the application to be accessed through a standard HTTP URL. Equivalently, the link to the helper component can act as a proxy to the application.

Alternative ways of using a helper application to launch and configure a main application are also possible. For example, one could use a standard http URL to reach the service web site which then responds with a Java applet, or equivalent code (native code, Flash ActionScript, JavaScript, etc.), that, when executed on the originating system, communicates with the helper application in order to initiate a service. In such a configuration, the communication of the received code with the helper application may use a proprietary, non-standard protocol. In the following, the terms helper or proxy application, and helper or proxy link, refer to all these different mechanisms, regardless if they use a standardized protocol and link structure or not, and regardless if the link points initially to an external site or directly to a local resource.

The use of a helper or proxy may be complicated in a VDI environment due to the physical and logical separation of the client and server components of the VDI system implementation, and the fact that the VDI server may run multiple instances of any given application. The problem can be demonstrated using the following example. With reference to FIG. 1, assume that a user running a VDI Client 156 receives an email with a URL that enables her to connect to a scheduled video conference. The link may allow the user to connect as a “guest”, i.e., no user authentication is required. The link is supposed to be used by multiple users, and hence does not provide any information identifying the user that received the link. The link may encode the network location of the virtual room where the meeting is to take place. When the user accesses the link, the web browser in invoked and the user is taken to the web site of the service, which in turn sends back service initialization data, together with appropriate executable code that, when executed, will provide the service initialization data to the videoconference application and enable it to connect to the room. This works well in a non-VDI system, where there is a single instance of videoconference application running, associated with a single user.

According to the VDI application design, the web browser will be physically running on the VDI Server 154, and only the display (and interaction) will be performed on the VDI Client 156 through the connection 160. The helper application as well as the main (videoconferencing) application, if separate, will be running on the VDI Server 154 as well, listening on the specified application-specific port. If the VDI Server 154 allows multiple users without each one being assigned its own virtual host, multiple helper applications can not all be listening on the same port. It is also not possible for the helper to directly identify the instance of the videoconferencing application that it should connect to, when they are implemented as two separate components. This is because the initiating link, and the service data, do not provide information about the user who initiated the service request, but only of the offered service.

A similar problem occurs when more than one VDI Server 154 is involved, which may happen when a user access applications from two different VDI systems. For example, a user may run their web browser on a server A, but run the videoconferencing application on server B. In this example, a URL that is local on the application running on server A will not be able to locate the helper component of the main application because it will reside on a different server, server B. This example may occur when application virtualization is used, since these system optimize the allocation of applications to servers and could thus easily result in a virtual desktop environment where different applications are running on different servers.

It is therefore necessary to provide systems and methods that allow for the resolution of service initialization links in VDI environments, with one or more servers.

### BRIEF DESCRIPTION OF THE DRAWINGS

FIG. 1 illustrates the architecture of an exemplary VDI system;

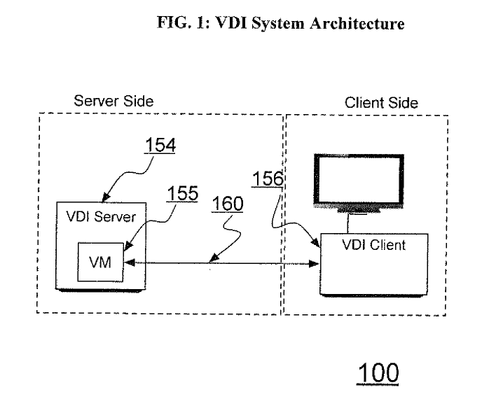

FIG. 2 illustrates the architecture of an exemplary video communication system;

FIG. 3 depicts an exemplary VDI system integrating video communication functionality in accordance with one or more embodiments of the disclosed subject matter;

FIG. 4 depicts an exemplary alternative VDI system integrating video communication functionality in accordance with one or more embodiments of the disclosed subject matter;

FIG. 5 depicts an exemplary proxy architecture in accordance with one or more embodiments of the disclosed subject matter;

FIG. 6 depicts an exemplary proxy architecture using as an example two clients, in accordance with one or more embodiments of the disclosed subject matter;

FIG. 7 depicts an exemplary proxy architecture for multiple VDI n accordance with one or more embodiments of the disclosed subject matter;

FIG. 8 depicts an exemplary flow chart for using service initialization links in a single VDI server environment;

FIG. 9 depicts an exemplary flow chart for using service initialization links in a multiple VDI server environment; and

FIG. 10 depicts an exemplary computer system for implementing one or more embodiments of the disclosed subject matter.

Throughout the figures the same reference numerals and characters, unless otherwise stated, are used to denote like features, elements, components or portions of the illustrated embodiments. Moreover, while the disclosed subject matter will now be described in detail with reference to the figures, it is done so in connection with the illustrative embodiments.

### DETAILED DESCRIPTION

The present disclosure describes systems and methods for resolving service initialization links in a VDI system. The disclosure is described from the point of view of a videoconferencing application, although of course the same design can be used in any application which is initiated locally in a system, but using information obtained from external means. We are particularly interested in the case where the external service initialization information may not identify the originating party (e.g., a guest link to a videoconference) and where the application is hosted on a VDI server.

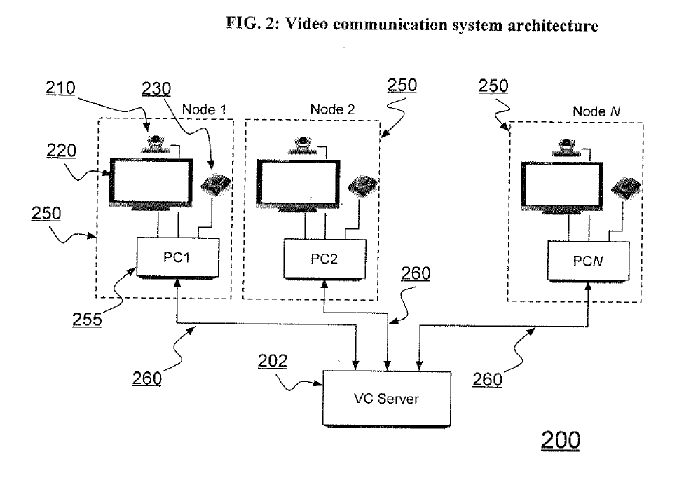

FIG. 2 shows the architecture of a typical videoconferencing system 200. The system shows a number of Endpoints 250 (1 through N) connected through a Videoconferencing (VC) Server 202 over Network Connections 260. The Network Connections 260 transfer both signaling as well as media (video, audio, content, etc.) data. Endpoints 250 include, as an example, a Personal Computer 255, a Display 220, a Camera 210, and a Speakerphone 230. This is just an example and other endpoint configurations are possible, including iPads, smartphones, etc., as well as endpoints with video only, audio only, or content-only capability.

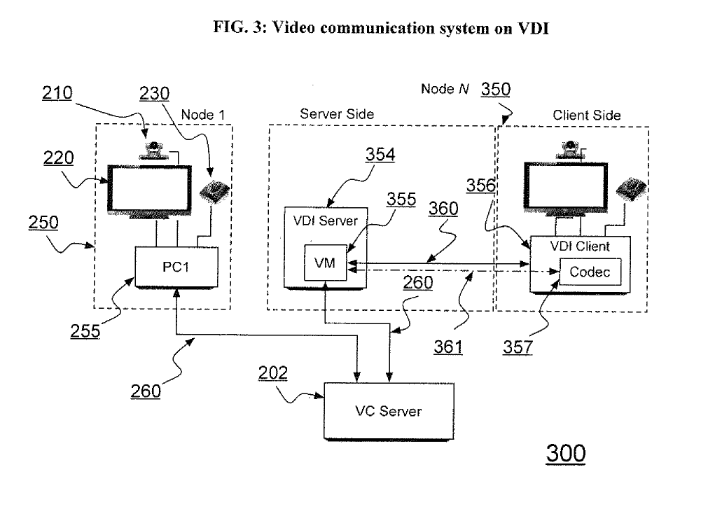

FIG. 3 shows the system architecture of a videoconferencing system 300 in which one of the endpoints is implemented using a VDI architecture of the disclosed subject matter. Modules that are identical with FIG. 2 have the same identifying number. In this figure, Node N is a VDI Endpoint 350. The Endpoint 350 includes a VDI Server 354 that runs a VM (virtual machine) component 355 on the server side, and a VDI Client 356 that contains a Codec Component 357 on the client side.

The VM 355 can run the regular videoconferencing application except from media processing and rendering (encoding, decoding, display) and can communicate with the VC server 202. The client side of the VDI system can be a regular VDI client with the addition of the Codec 357 component. All media encoding and decoding can occur on the Codec 357. The application running on the VM 355 is responsible for passing through compressed audio, video, and optionally content data, received from the VC Server 202 to the Codec 357 for decoding, rendering, and playback/display. The videoconferencing application running on the VM 355 is also responsible for passing through compressed audio and video received from the Codec 357 to the VC Server 202 for forwarding to other endpoints. This may be video and audio captured by a camera and microphone, respectively, located at the VDI Client 356.

The communication between the application running on the VM 355 and the Codec 357 can be performed through a Network Connection 361. In one embodiment of the disclosed subject matter, the Network Connection 361 may be part of the PCoIP connection that is established between the server and client components of the VMware View architecture. In this instance, the multimedia data may be “tunneled” through the PCoIP connection (Network Connection 360) between the application running on the VM 355 on the server side, and the Codec 357 that is built into the VDI client on the client side. Other means of communication between the VM 355 and the Codec 357 are of course possible. Different network connections may be used for the regular VDI data and the coded media data.

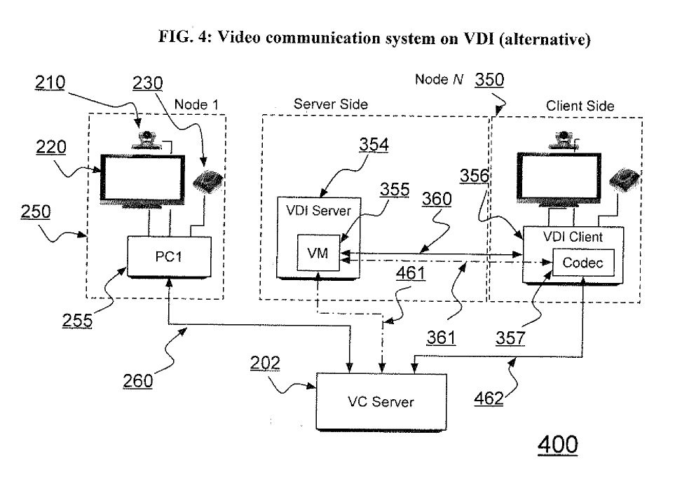

FIG. 4 shows an alternative configuration, in which the communication between the VDI Endpoint 350 and the VC Server 202 is split into two. A first component involves a Network Connection 461 between the VM 355 and the VC Server 202 that carries only signaling and other application data, and another Network Connection 462 between the Codec 357 and the VC Server 202 that carries compressed media data. This alternative embodiment has a benefit that multimedia data is routed directly to and from the location where it is decoded or encoded, but can have drawbacks in terms of managing security and authentication.

The architectures shown in FIG. 3 and FIG. 4 address the issue of bit rate management and computational load partitioning in an effective way. The load on the Network Connections 360 and 361 between the server side and client side of the Endpoint 350 is reduced, whereas any video hardware acceleration capability that may exist on the VDI Client 356 hosting the Codec 357 is fully utilized. Alternatively, all media encoding and decoding would have to be performed on the VDI Server, necessitating the transmission of uncompressed media over the Network Connection 360. This could easily overwhelm available network connections in existing publicly available networks.

Our description of service initialization link resolution will be based on the design of FIG. 3, but it applies in essentially the same way to all three different configurations (the two with the codec at the Client Side, and the brute-force placement of the codec in the Server Side). This is because the initialization of the application does not depend on the internal architecture of where media processing may take place. Indeed, it applies to any application that is initialized by a link, regardless if it is a communication application involving audio and video or not.

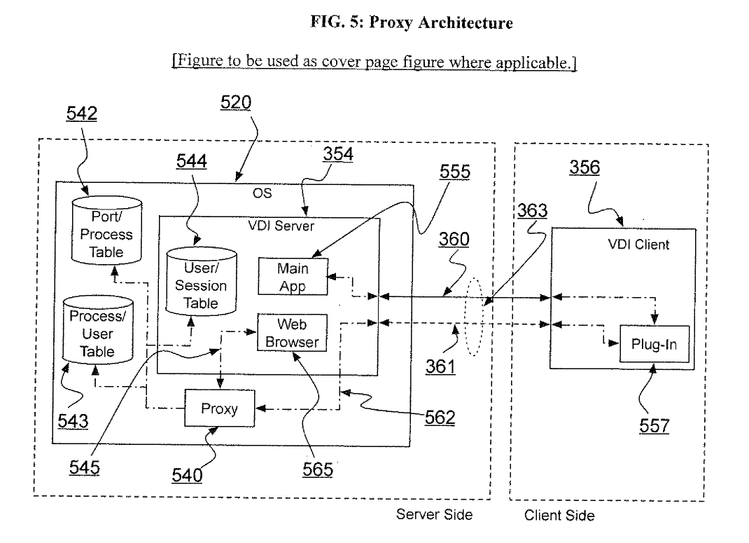

We describe the link resolution process for initiating a service associated with an application called Main App with reference to FIG. 5. As with FIG. 3, FIG. 5 shows a Client Side and a Server Side. On the Client Side, FIG. 5 shows the VDI Client 356 and a Plug-In 557. The Plug-In 557 may include a Codec 357 as in FIG. 3 or FIG. 4, but a Codec is not required. The VDI Client 356 can connect to a VDI Server 354, and specifically to an application Main App 555 hosted at the VDI Server 354. The connection can be performed through the Network Connection 360. The Plug-In 557 runs within the VDI Client 356, and may have a separate Network Connection 361 with the Main App 555. As explained earlier, in one embodiment this may be a tunnel through the Network Connection 360. In other embodiments in may be a separate network connection, or it may also be the same Network Connection 360. We note that the Network Connections 360 and 361 are managed by the VDI system. The Plug-In Network Connection 361, specifically, may be accessible by the VDI Server so that it, or other processes, can inject messages to that connection, to be received by the Plug-In 557. The set of connections between the VDI Server 354 and a particular VDI Client 356 is identified as a Session 363.

We now describe operation when the user is accessing a URL or link that initiates a service. In one embodiment, the link will direct a Web Browser 565 that runs on the VDI Server 354 (and displays on the VDI Client 356) to access the web site and obtain the information required to initialize and access the service. In one embodiment, the information includes a Flash code that executes on the Web Browser 565 and which connects to a Proxy 540 process that runs on the host Operating System 520 of the computer where the VDI Server runs. The Proxy 540 is shown as a separate process from the VDI Server 354 in FIG. 5, but in some embodiments it may be integrated with the VDI Server 354.

The Proxy 540 is accessed on a well-known port of the local host, such as 8888, through a local Network Connection 545. The port may be uniquely associated with the particular application Main App. The connection is local in that, although the networking API of the Operating System 520 may be used, no physical network may be accessed. Alternative ways to connect to the Proxy 540 are known, including named pipes, where file system entry points are used for communication between operating system processes, or shared memory. When the Flash code (or equivalent) connects to the Proxy 540, the Proxy 540 may not know the identity of the user which initiated the connection. It will only get the information necessary in order to initialize the application and access the service. In a videoconferencing application example, this may include the server domain name and the virtual room identifier. If multiple Main App 555 instances are running on the VDI Server 354 (or Operating System 520), the Proxy 540 does not know which one made the request. This information is necessary in order for the Proxy 540 to pass along the service initialization information that it will obtain from the Web Browser 565 to the correct corresponding Main App 555.

The Proxy 540 can access services of the Operating System 520 and the VDI Server 354 in order to identify the correct Main App 555. The process can involve a number of lookup steps into appropriate tables, which will eventually allow the Proxy 540 to inform the correct Plug-In 557 that corresponds to the correct Main App 555. The steps may be different for different operating system instances, depending on how different data is organized internally.

In one embodiment of the present disclosure, the Proxy 540 first uses the remote port of the Connection 545 to identify the process ID of the process that initiated the connection. This may be performed by accessing a Port/Process Table 542 maintained by the Operating System 520. Such information is maintained, for example, in the Microsoft Windows Operating System, among others. The Operating System 520 provides suitable Application Programming Interface (API) calls so that applications can retrieve this information. After the Proxy 540 retrieves the process ID from the Port/Process Table 542, it then retrieves the user ID of the user that initiated the particular connection by accessing a Process/User Table 543. Again, this information can be provided by the Operating System 520 using standard API calls. Finally, from the user ID, the Proxy 540 can retrieve the session ID that the particular user is using on the VDI Server by accessing a User/Session Table 544 maintained by the VDI Server 354.

In some embodiments where the VDI system is implemented using Microsoft Terminal Server services (e.g., the commercially available Citrix XenApp), the Remote Desktop Services API functions provide an array of calls for obtaining this information. One example is WTSEnumerateSessions, which returns WTS_SESSION_INFO structures that contain information that includes the “SessionId”.

After the Proxy has obtained the session ID for the VDI connection of the user that initiated the request, it can inject in the particular Network Connection 361 maintained by the VDI Server 354 for the particular VDI Client (the one that the user is using) the information necessary for the Main App 555 to connect to the service. The information will be retrieved by the Plug-In 557 and sent through the Network Connection 360 to the Main App 555 to initiate the service.

In summary, after the Web Browser 565 obtains the necessary service initialization information, including and associated helper code, the Proxy 540 identifies the particular Network Connection 361 where it can reach the Plug-In 557 of the VDI Client of the user that initiated the connection to the Proxy, and sends the necessary service information through that connection to the Plug-In 557, which then forwards it to the Main App 555.

Although FIG. 5 shows only one VDI Client 356, the disclosed architecture applies to any number of VDI clients. It also applies in an identical fashion regardless if VDI clients are running on the same computer system or different computer system.

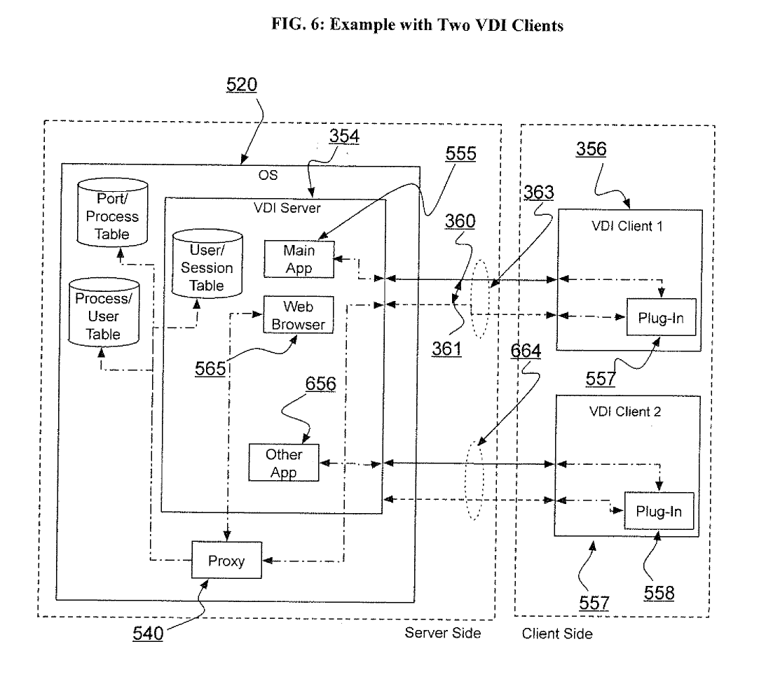

FIG. 6 shows an example of the same architecture depicted in FIG. 5 where two VDI Clients are explicitly shown. The use of two clients is just for illustration purposes and any number of clients may be used. In the diagram of FIG. 6 we removed several of the labels of FIG. 5 to make it less cluttered. The new elements in the diagram are the second VDI Client 2 557, which—like Video Client 1 356—runs an instance of the Plug-In 558. This second VDI Client 2 557 has a separate, second Session 664 with the VDI Server 354. The VDI Client 2 557 in this example is running an application called Other App 656, which communicates with its corresponding VDI Client 2 447 over the Session 664. When the Proxy 540 obtains the session ID, it will send the service information over the Session 363 associated with the VDI Client 1 356, and not over the Session 664 associated with VDI Client 2 557 since it will be associated with a different user ID.

The multiple VDI Clients shown in FIG. 6 may run on the same computer system or in different computer systems. The architecture described herein remains the same as long as all applications are hosted on the same VDI Server 354. This is because the Proxy 540 will be able to resolve the link and reach the appropriate application through the corresponding Plug-In at the VDI client side. As one of skill in the art would understand, the architecture may require a modification, however, if two or more VDI Clients run on the same computer, and at least two run applications that are hosted in different VDI servers. This is a scenario that is likely to occur in large installations that involve multiple servers, or servers dedicated to serve particular applications.

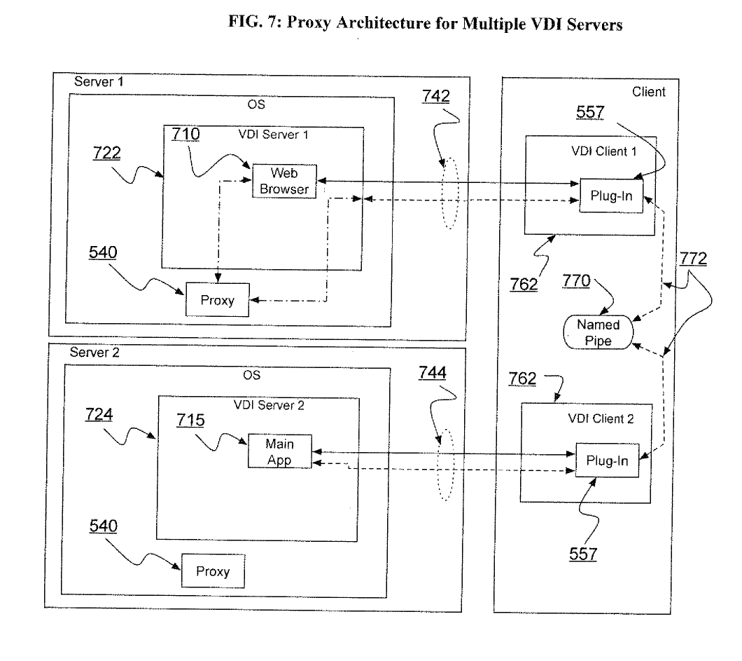

FIG. 7 depicts an example configuration of a client system that runs at least two applications that are hosted on two different VDI servers. The figure shows a Client system that has a VDI Client 1 762 running, in this example, a Web Browser 710 application on VDI Server 1 722 which is hosted on Server 1, and second VDI Client 2 762 running, in this example, the Main App 715 on a second VDI Server 2 724 hosted on Server 2. We assume that the service link is accessed on the Web Browser 710 which is hosted on VDI Server 1 722, whereas the Main App 715 runs on the separate server, VDI Server 2 724. In order to properly communicate the information provided from the link accessed at the Web Browser 710 to the Main App 715, all VDI client instances run the Plug-In 557. The instances communicate with each through an inter-process communications facility on the Client system. In some embodiments of the present disclosure the communication may be through a Named Pipe 770. Other means of communication may be used, including shared memory, local files, etc. The Plug-In 557 can detect if it is running on a VDI Client that is associated with the application it has been designed for, so that it knows if it should provide it the service information.

We now describe an exemplary flow of information assuming that the user accesses a link on the Web Browser 710 running on VDI Server 1 722. As with the single server case, the Web Browser 710 will obtain Flash code or the equivalent operating commands to send the service information to the Proxy 540 running on Server 1. The Proxy 540 will perform, as before, the process of looking up the appropriate session ID and will identify the Session 742 to send the service information to the corresponding Plug-in 557 of VDI Client 1 762. The Plug-In 557 of VDI Client 1 will detect that it is not associated with its Main App, and will connect to the Named Pipe 770 transmitting the service initialization information. The Plug-In 557 of VDI Client 2 762 will intercept the data and, knowing that it is associated with the Main App 715, it will forward the service information to the Main App 715 through the Session 744. This will allow the Main App 715 to initiate the service as instructed by the command executed on the Web Browser 710 of the other server. In this example, the Proxy 540 running on Server 2 is not utilized.

In some embodiments, the Proxy 540 and Plug-In 557 are designed for a particular application (here referred to as Main App). The Proxy 540 and Plug-In 557 can also be designed, however, to work for a plurality of applications. The Proxy 540 can include application information in its communication to the Plug-In 557 by using, as an example, the port number that it was contacted at. Other techniques may be used, including the schema, the domain name itself, etc. This way the same combination of Proxy/Plug-In tools can be used to provide link resolution to all applications that may run on a particular client, regardless of how many servers are employed.

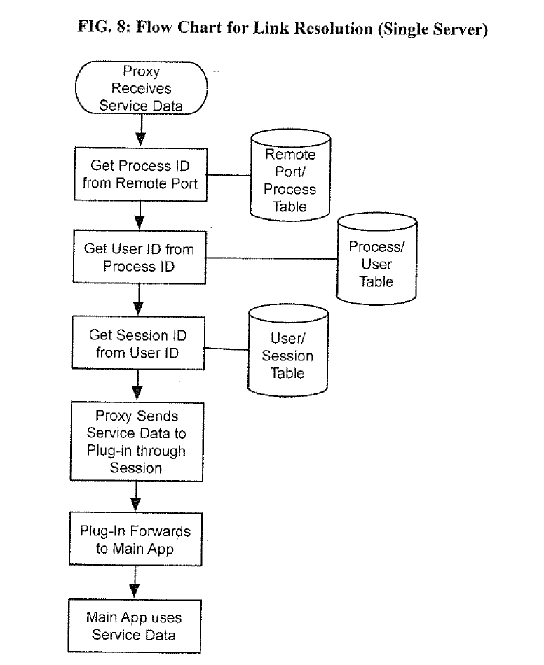

FIG. 8 depicts an exemplary flow chart for the service initialization link resolution process when a single server is involved. The process starts when the Proxy receives service data. As discussed earlier, this may be through code downloaded from a web site through a link accessed from a web browser. The process involves a number of steps for identifying the session ID; in this example the steps require a lookup of the process ID from the remote port, then the user ID from the process ID, and finally the session ID from the user ID. The Proxy the sends the service data through the session identified by the session ID to the Plug-In. The Plug-In then sends it through its session to the Main App, which in turn uses it to initiate the desired service.

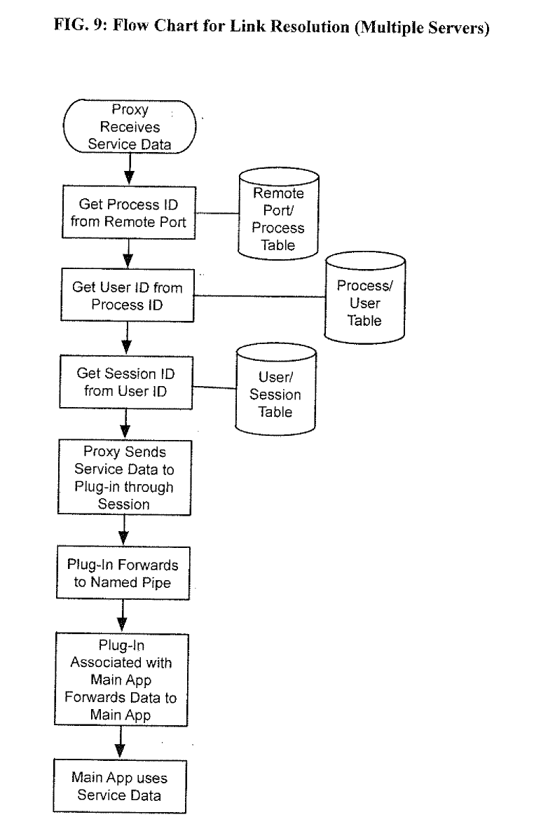

FIG. 9 depicts an exemplary flow chart when multiple VDI servers are involved. In this example, the last two steps are modified. The Plug-In that receives the service data from the Proxy forwards it to a Named Pipe. The service data is then picked up by the Plug-In that is associated with the Main App, which then forwards to the Main App. As before, the Main App then uses it to initiate the desired service.

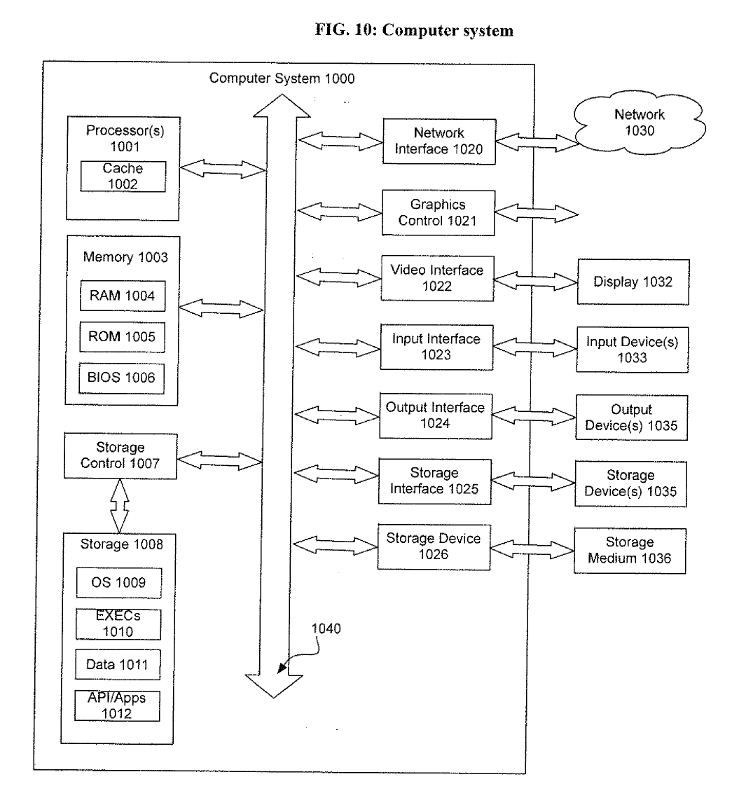

The methods for resolving service initialization links in VDI environments described above can be implemented as computer software using computer-readable instructions and physically stored in computer-readable medium. The computer software can be encoded using any suitable computer languages. The software instructions can be executed on various types of computers. For example, FIG. 10 illustrates a computer system 1000 suitable for implementing embodiments of the present disclosure.

The components shown in FIG. 10 for computer system 1000 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Computer system 1000 can have many physical forms including an integrated circuit, a printed circuit board, a small handheld device (such as a mobile telephone or PDA), a personal computer or a super computer.

Computer system 1000 includes a display 1032, one or more input devices 1033 (e.g., keypad, keyboard, mouse, stylus, etc.), one or more output devices 1034 (e.g., speaker), one or more storage devices 1035, various types of storage medium 1036.

The system bus 1040 link a wide variety of subsystems. As understood by those skilled in the art, a “bus” refers to a plurality of digital signal lines serving a common function. The system bus 1040 can be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 1001 (also referred to as central processing units, or CPUs) optionally contain a cache memory unit 1002 for temporary local storage of instructions, data, or computer addresses. Processor(s) 1001 are coupled to storage devices including memory 1003. Memory 1003 includes random access memory (RAM) 1004 and read-only memory (ROM) 1005. As is well known in the art, ROM 1005 acts to transfer data and instructions uni-directionally to the processor(s) 1001, and RAM 1004 is used typically to transfer data and instructions in a bi-directional manner. Both of these types of memories can include any suitable of the computer-readable media described below.

A fixed storage 1008 is also coupled bi-directionally to the processor(s) 1001, optionally via a storage control unit 1007. It provides additional data storage capacity and can also include any of the computer-readable media described below. Storage 1008 can be used to store operating system 1009, EXECs 1010, application programs 1012, data 1011 and the like and is typically a secondary storage medium (such as a hard disk) that is slower than primary storage. It should be appreciated that the information retained within storage 1008, can, in appropriate cases, be incorporated in standard fashion as virtual memory in memory 1003.

Processor(s) 1001 is also coupled to a variety of interfaces such as graphics control 1021, video interface 1022, input interface 1023, output interface 1024, storage interface 1025, and these interfaces in turn are coupled to the appropriate devices. In general, an input/output device can be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 1001 can be coupled to another computer or telecommunications network 1030 using network interface 1020. With such a network interface 1020, it is contemplated that the CPU 1001 might receive information from the network 1030, or might output information to the network in the course of performing the above-described method. Furthermore, method embodiments of the present disclosure can execute solely upon CPU 1001 or can execute over a network 1030 such as the Internet in conjunction with a remote CPU 1001 that shares a portion of the processing.

According to various embodiments, when in a network environment, i.e., when computer system 1000 is connected to network 1030, computer system 1000 can communicate with other devices that are also connected to network 1030. Communications can be sent to and from computer system 1000 via network interface 1020. For example, incoming communications, such as a request or a response from another device, in the form of one or more packets, can be received from network 1030 at network interface 1020 and stored in selected sections in memory 1003 for processing. Outgoing communications, such as a request or a response to another device, again in the form of one or more packets, can also be stored in selected sections in memory 1003 and sent out to network 1030 at network interface 1020. Processor(s) 1001 can access these communication packets stored in memory 1003 for processing.

In addition, embodiments of the present disclosure further relate to computer storage products with a computer-readable medium that have computer code thereon for performing various computer-implemented operations. The media and computer code can be those specially designed and constructed for the purposes of the present disclosure, or they can be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter. Those skilled in the art should also understand that term “computer readable media” as used in connection with the presently disclosed subject matter does not encompass transmission media, carrier waves, or other transitory signals.

As an example and not by way of limitation, the computer system having architecture 1000 can provide functionality as a result of processor(s) 1001 executing software embodied in one or more tangible, computer-readable media, such as memory 1003. The software implementing various embodiments of the present disclosure can be stored in memory 1003 and executed by processor(s) 1001. A computer-readable medium can include one or more memory devices, according to particular needs. Memory 1003 can read the software from one or more other computer-readable media, such as mass storage device(s) 1035 or from one or more other sources via communication interface. The software can cause processor(s) 1001 to execute particular processes or particular parts of particular processes described herein, including defining data structures stored in memory 1003 and modifying such data structures according to the processes defined by the software. In addition or as an alternative, the computer system can provide functionality as a result of logic hardwired or otherwise embodied in a circuit, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosed subject matter. It will thus be appreciated that those skilled in the art will be able to devise numerous systems and methods which, although not explicitly shown or described herein, embody the principles of the disclosed subject matter and are thus within its spirit and scope.

What is claimed is:

1. A system for resolving service initialization requests associated with an application running in a virtual desktop infrastructure (VDI), the system comprising:
a server coupled to and adapted to run a VDI server hosting the application;
a VDI client coupled to the VDI server over a communication network through a VDI session;
a proxy to run on the server; and
a plug-in to run in the VDI client;
wherein the proxy is configured to: receive service initialization requests, identify the session that corresponds to the user that initiated the service initialization request, and transmit it to the plug-in through the VDI session; and
wherein the plug-in is further configured to transmit the service initialization request to the application through the VDI session.

2. The system of claim 1, wherein the server further comprises an operating system, wherein the service initialization request comprises connecting to a communication port where the proxy is awaiting connection requests, and wherein identification of the session that corresponds to the user that initiated the service initialization request comprises retrieving from the computer system's operating system a process ID from the remote port number of the service initialization request, a user ID from the process ID, and, from the VDI server, a session ID from the process ID.

3. A system for resolving service initialization requests associated with an application running in a virtual desktop infrastructure (VDI), the system comprising:
one or more servers coupled to and adapted to run a plurality of VDI servers hosting the application as well as other applications;
a client to run one or more VDI clients each coupled to one associated VDI server of the plurality of VDI servers over a communication network through an associated VDI session;
a plurality of proxies to run on the one or more servers and coupled to associated VDI servers of the plurality of VDI servers; and
a plug-in to run in each VDI client and coupled to its associated VDI server over the communication network through the associated VDI session,
wherein the proxies are configured to: receive service initialization requests, identify the session that corresponds to the user that initiated the service initialization request, and transmit it over the VDI session to the plug-in of the VDI client associated with the VDI server that they are associated with, and
wherein the plug-in is configured to: if it is running on a VDI client that is associated with the VDI server that runs the application, transmit the service initialization request to the application over the associated VDI session; and if it is running on a VDI client that is not associated with the application, transmit the service initialization request to all plug-ins running on the client through a local connection, so that the plug-in running on the VDI client associated with the application receives the service initialization request and forwards it to the application over its associated VDI session.

4. The system of claim 3, wherein the server further comprises an operating system, wherein the service initialization request comprises connecting to a communication port where the proxy is awaiting connection requests, and wherein identification of the session that corresponds to the user that initiated the service initialization request comprises retrieving from the computer system's operating system a process ID from the remote port number of the service initialization request, a user ID from the process ID, and, from the VDI server, a session ID from the process ID.

5. The system of claim 3, wherein the local connection on the client comprises one of a named pipe, shared memory, or shared file.

6. A method for resolving service initialization requests associated with an application running in a virtual desktop infrastructure (VDI) on a system including: a server running a VDI server hosting the application; a VDI client coupled to the VDI server over a communication network through a VDI session; a proxy running on the server and coupled to the VDI server; and a plug-in running in the VDI client coupled to the VDI server over the communication network, the method comprising:
by the proxy, receiving service initialization requests, identifying the session that corresponds to the user that initiated the service initialization request, and transmitting it to the plug-in through the VDI session; and
by the plug-in, transmitting the service initialization request to the application through the VDI session.

7. The method of claim 6, wherein the server further comprises an operating system, wherein the service initialization request comprises connecting to a communication port where the proxy is awaiting connection requests, and wherein identification of the session that corresponds to the user that initiated the service initialization request comprises retrieving from the computer system's operating system a process ID from the remote port number of the service initialization request, a user ID from the process ID, and, from the VDI server, a session ID from the process ID.

8. A method for resolving service initialization requests associated with an application running in a virtual desktop infrastructure (VDI), on a system comprising: one or more servers running a plurality of VDI servers hosting the application as well as other applications; a client running one or more VDI clients each coupled to one associated VDI server of the plurality of VDI servers over a communication network through an associated VDI session; a plurality of proxies running on the one or more servers and coupled to associated VDI servers of the plurality of VDI servers; and a plug-in running in each VDI client and coupled to its associated VDI server over the communication network through the associated VDI session, the method comprising:
by the proxies, receiving service initialization requests, identifying the session that corresponds to the user that initiated the service initialization request, and transmitting it over the VDI session to the plug-in of the VDI client associated with the VDI server that they are associated with, and
by the plug-in: if it is running on a VDI client that is associated with the VDI server that runs the application, transmitting the service initialization request to the application over the associated VDI session; and if it is running on a VDI client that is not associated with the application, transmitting the service initialization request to all plug-ins running on the client through a local connection, so that the plug-in running on the VDI client associated with the application receives the service initialization request and forwards it to the application over its associated VDI session.

9. The system of claim 3, wherein the server further comprises an operating system, wherein the service initialization request comprises connecting to a communication port where the proxy is awaiting connection requests, and wherein identification of the session that corresponds to the user that initiated the service initialization request comprises retrieving from the computer system's operating system a process ID from the remote port number of the service initialization request, a user ID from the process ID, and, from the VDI server, a session ID from the process ID.

10. The system of claim 3, wherein the local connection on the client comprises one of a named pipe, shared memory, or shared file.

11. A non-transitory computer readable medium comprising a set of executable instructions to direct a processor to perform the method in one of claims 6-10.
